(19) United States
(12) Patent Application Publication
(10) Pub. No.: US 2024/0403612 A1
(43) Pub. Date: Dec. 5, 2024

(54) SYSTEM AND METHOD FOR IMPROVING RESULTS FROM ARTIFICIAL INTELLIGENCE

(71) Applicant: Augment Legal, Inc., Arlington, VA (US)

(72) Inventor: Rix Ryskamp, Arlington, VA (US)

(73) Assignee: Augment Legal, Inc., Arlington, VA (US)

(21) Appl. No.: 18/678,807

(22) Filed: May 30, 2024

Related U.S. Application Data
(60) Provisional application No. 63/577,872, filed on May 30, 2023.

(51) Int. Cl. G06N 3/0475; G06N 3/08

(52) U.S. Cl. CPC G06N 3/0475; G06N 3/08

(57) ABSTRACT

This invention improves the results that a user receives from a generative artificial intelligence. It accomplishes this by learning about user preferences from various user data and activities. It then provides more meaningful requests to the artificial intelligence based on such data. These more meaningful requests produce more meaningful results for users.

### CROSS-REFERENCE TO RELATED APPLICATIONS

This application claims the benefit of U.S. Provisional Application No. 63/577,872, filed May 30, 2023, for SYSTEM AND METHOD FOR IMPROVING RESULTS FROM ARTIFICIAL INTELLIGENCE, which is incorporated herein by reference.

### BACKGROUND

This invention is in the field of generative artificial intelligence (AI). Generative AI can be used to generate text, images, video, audio, 3D models, computer programs, computer code, binary data, structured data, and other many other media. It can also be used to edit or modify existing versions of such media.

The current state of the art is represented by generative AIs such as OpenAI GPT-4, Google PaLM 2, Meta LLaMA, and other commercial and open sources generative AI systems. Other examples of current generative AIs include Lex, Dall-E 2, Midjourney, Stable Diffusion, Amper, Dadabots, MuseNet, CodeStarter, Codex, GitHub Copilot, Tabnine, Descript, Listnr, and Podcast.ai.

### SUMMARY

### Description of the Problem

Generative AI systems can create AI-generated content for users. However, these systems are typically trained to create the same or similar content responses for every user that provides a given request. These inherently similar responses reduce the usefulness of generative AI in cases where users desire to produce content that is original. Generic content is also less helpful because it is less meaningful than content that is targeted at the specific tastes, needs, and desires of a particular user. In this document this problem will be referred to as the “generic response problem.”

One method for solving the generic response problem is for users of generative-AI to create long and detailed requests with many keywords that specify their individual needs to create unique, specific, and individualized content. In other words, their responses from the AI system become unique because the user works to develop a prompt to the AI system that is unique.

For example, for a generative AI system that accepts text prompts as requests for generated content, two users that both provide a prompt to the generative AI system that states “write an essay on the city of Dumaguete, Philippines” might receive very similar, or even identical, results. But a user might have specific preferences about the style, format, or other attributes of the essay and might accordingly change their prompt that includes some of those preferences, such as “Write an essay on the city of Dumaguete, Philippines. Always use the Oxford comma. Focus on the local people. Use a bulleted list. Do not exceed 800. Use an introductory and a conclusion paragraph. Do not discuss politics.” Making a more detailed prompt makes the resulting generated output more specific to the user's needs, but it also adds the burden of providing very detailed prompts, and such detail might reduce the benefits (e.g., time savings, ease-of-use, etc.) of having the AI generate the essay in the first place. This problem is not unique to text-focused generative AI systems. The generic response problem exists for both creating and modifying media including, but not limited to text, audio, images, video, 3D models, structured data, computer code, computer programs, binary data, structured data, and other media.

### How the Invention Addresses the Problem:

The invention assists users (or their agents) by creating output from a generative AI system that is specifically tailored to their preferences. The invention may learn about these preferences by reviewing existing data related to the user (e.g., stored preferences, media created or modified by the user, media not created or modified by the user but identified as useful, etc.) or by monitoring a user's interactions (e.g., by observing how users interface with media, messaging interactions, searching interactions, social media interactions, etc.). These preferences are then included in modification information that enhances the users' requests to the generative AI. Modification information could be provided to the AI by modifying requests sent by the user to the generative AI, or by providing modification information directly to the user for manual inclusion in a request, or by some other means. As a result of the invention's introduction of modification information into the user's requests to the generative AI system, generated responses from that system may be more specific to user needs and preferences, and thus the invention may enhance the users' experience with generative AI systems.

For example, consider the case above where the user wanted to generate an essay through a generative AI system. Without this invention, the prompt “write an essay on the city of Dumaguete, Philippines” will generate a generic response, as discussed above. However with this invention, such a simple prompt may result in a response from the generative AI system that is completely customized to the users' preferences. The invention will accomplish this by learning about user preferences from a plurality of learning sources, such as (a) the user's existing body of written work, (b) how the user edited previously generated written work, (c) the follow-up requests the user provided to the generative AI system to change to previous written work, (d) existing stored user preferences or other user history information, (e) written work not created by the user but which the user (or their agent) has identified as useful for generating preferences, or (f) any other source determined to be useful. The sources in this example are focused on text or written work but would be different if the example were for a different type of media (e.g., a video-focused example might review some video-centric data). The invention may make determinations based upon learning derived from these learning sources about what enhancements can be made to the prompt to make the resulting text more aligned with the user's preferences. In this example, the invention might make the determination that the user prefers essays that are limited to 500 words, perhaps because her favorite essays are 500 words or because she always edits generated essays to be about 500 words. The invention might then add the phrase “limit to 500 words” to the request prompt that is sent to the generative AI system. Or the invention might modify the request prompt to include the phrase “use the first person” because it determined that the user prefers essays written in the first person, perhaps because in previous essays she has provided a follow-up prompt to the generative AI stating, “change this to first person.” These examples illustrate very simple cases from the myriad ways that the invention can learn from the learning sources and subsequently modify a request to a generative AI system to better meet the needs or preferences of a user when generating or modifying any manner of media.

Note that the action of “modifying requests to” a generative AI system can occur internally within a single system. The invention sometimes describes separate components or systems, but in many cases several of the invention's components would be a native part of single system, such as generative AI system itself, and some of the modifications discussed would be internal to that single system.

Another aspect of the invention is that, in addition to enhancing requests from single generative AI systems, it also helps users select between AI systems, between outputs from several AI systems, or between different AI models in a single AI system. This aspect of the invention might automatically generate outputs from multiple generative AI systems and make a determination about which output (or combination of outputs) is best suited for the user's needs under the circumstances. Or in some cases it might make a determination about which generative AI system best matches the user's needs in advance and only request a response from the system (or combination of systems) determined to be appropriate for the user under the circumstances. In some cases it might work within an AI system to make a similar determination about which model, source, algorithm, or other element within the AI system might produce results most appropriate for the user under the circumstances. Determinations about what plurality of AI systems to select, what model or algorithm to select within an AI system, or whether to select them in advance or after receiving responses, might be learned from various learning sources (such as the learning sources discussed above). This selective aspect of the invention can help users select and merge data from different AI systems, models, algorithms, etc. based upon their individual preferences.

For example, again consider the scenario above where the user is generating an essay about the Philippines. This selective aspect of the invention would allow the user to generate essays from a plurality of generative AI systems. The invention could then automatically determine which of the generated responses best fit the user's needs or preferences. Alternatively, the invention could determine in advance which generative AI system is most likely to generate the best results for the given case and only request from that system. This pre-selection might be useful if some generative AI systems were more expensive than others, in which case cost information might be a factor in such a decision. The invention may also combine responses from multiple systems to create the best combined outcome. Such determinations will be made based upon the learned habits and preferences of the user as discussed in the previous examples and specifications, or they might involve requesting input from a user during operation. In this example, the essay about the Philippines could be drawn from several sources (e.g., GPT, PaLM, and LLaMA). The invention could then use the learned user preference from the sources discussed above to determine which of the three essays best matches the user's preferences. Or it might create a combination of results from the different sources, either by using learned user preferences or by asking the user which portions it prefers (e.g., by prompting to user with “which version of this sentence do you prefer?”). Or the invention might break the request into several sub-requests to use benefits of each AI system, model, or other AI element (e.g., “write an intro paragraph about . . . ” is sent to GPT, “write a paragraph about the people of . . . ” is sent to PaLM, and “write a conclusion paragraph about . . . ” is sent to LLaMA) and the results could be merged to provide a hybrid result. As with other examples, different media content might be handled differently, as discussed above.

### BRIEF DESCRIPTION OF THE DRAWINGS

FIG. 1 illustrates a manner in which the User Specific Learning Manager (USLM) might monitor, modify, and forward requests and responses between a User Agent and an AI System.

FIG. 2 illustrates some of the learning sources through which the USLM might learn about user preferences.

FIG. 3 illustrates the process by which user editing activities might be monitored to assist the invention in learning about user preferences.

FIG. 4 illustrates how AI generated modification requests and subsequent responses might be monitored to assist the invention in learning about user preferences.

FIG. 5 illustrates how user feedback might assist the invention in learning about user preferences.

FIG. 6 illustrates how requests to and responses from multiple AI Systems might be automatically managed by the invention.

FIG. 7 illustrates how the entire system might be structured as part of a single AI System.

### DETAILED DESCRIPTION

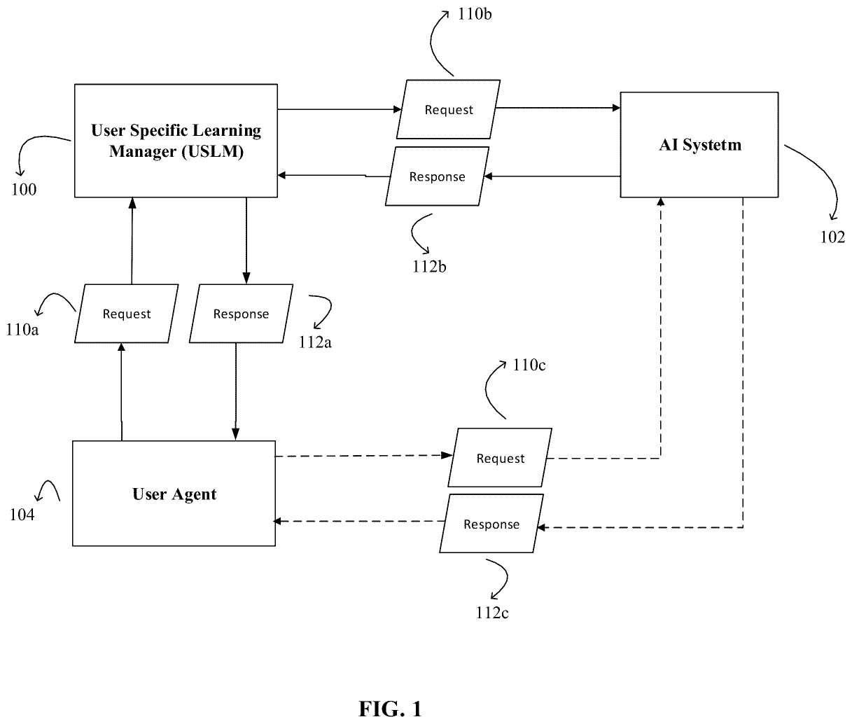

FIG. 1 illustrates how the User Specific Learning Manager (USLM) 100 might monitor, modify, and forward requests 110a from the User Agent 104 and responses 112b from the AI system 102 by (a) accepting requests 110a from the User Agent 104 and monitoring or modifying them before forwarding such requests 110b to the AI system 102, and (b) accepting responses 112b from the AI System 102 and monitoring or modifying them before forwarding such responses to the user 112a. In some cases, the User Agent 104 may communicate requests 110c to or receive responses 112c directly from the AI system 102. In cases where the User Agent 104 communications directly with the AI System 102, the USLM 100 might also receive copies of such requests 110a and responses 112b.

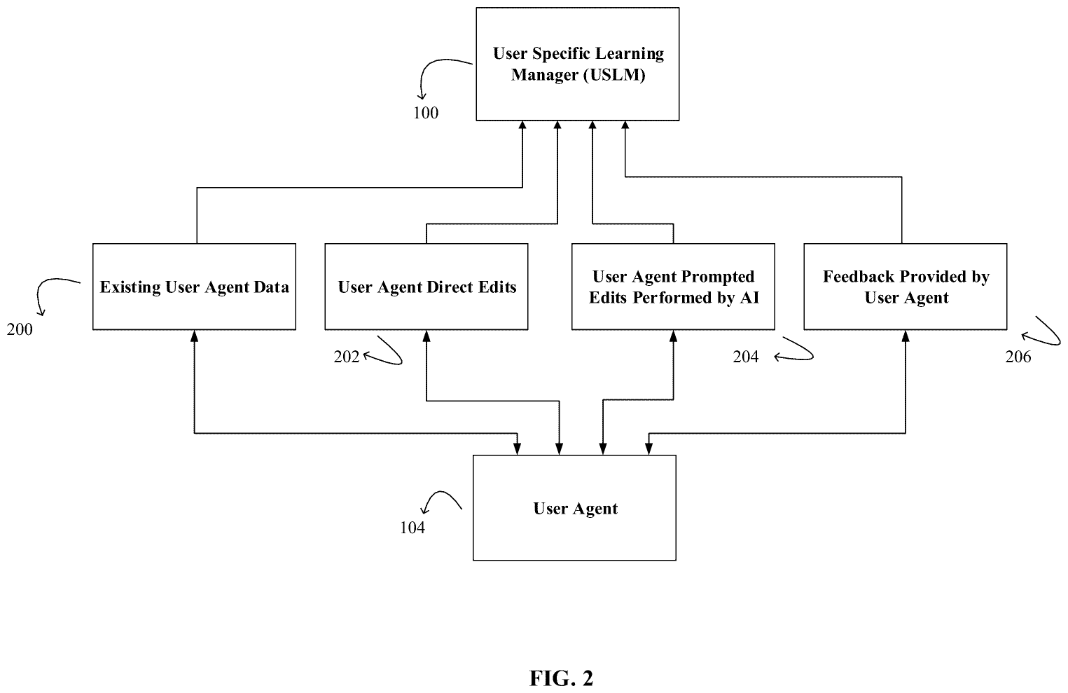

FIG. 2 illustrates some of the learning sources 200, 202, 204, 206 by which the USLM might learn about user preferences. Existing User Data 200 might include information that exists prior to a determination deemed useful for such a determination (e.g., samples of a user's previous work, stored user preferences, etc.). User Agent Direct Edits 202 come from monitoring the User Agent's 104 interactions with responses, both current and previous, from the USLM 100 (or sometimes directly from other sources). User Agent Prompted Edits Preformed by AI 204 come from monitoring the changes, both current and previous, that the User Agent 104 requests from the USLM 100 or the AI System 102 that modify an existing request already received by the User Agent 104. Feedback Provided by User Agent 206 is information learned from feedback from the User Agent 104 (or sometimes other sources) about a response. The USLM 100 may use all of these sources to learn about the preferences of the User Agent, as well as other sources as needed.

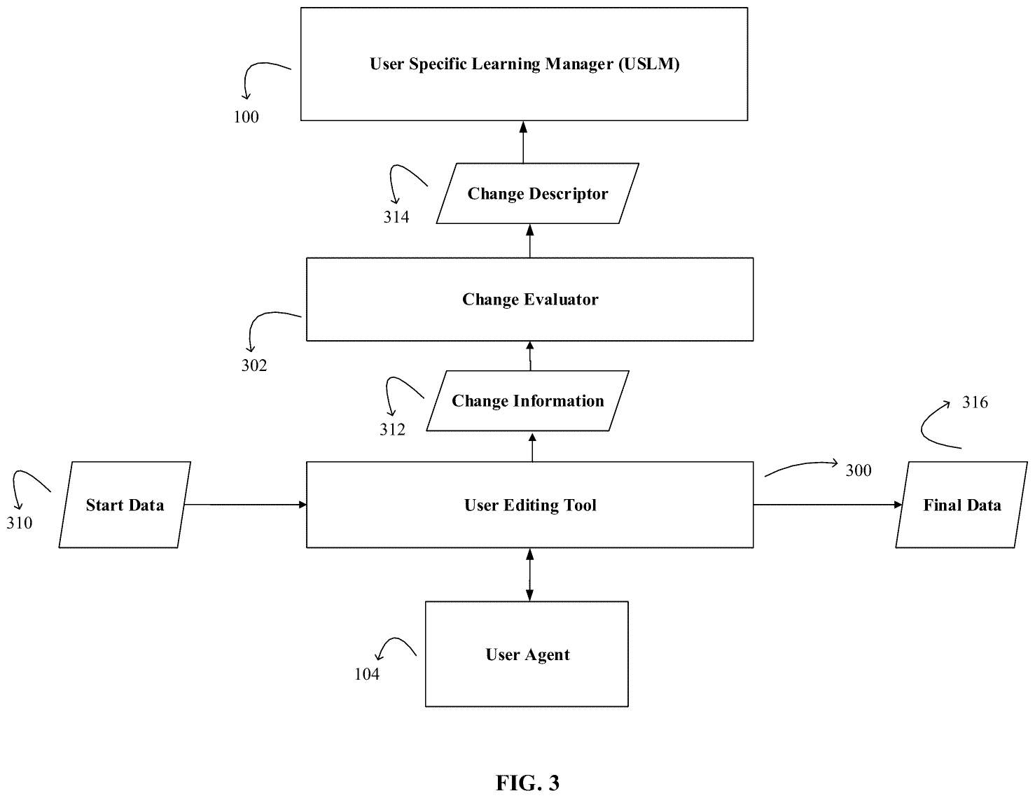

FIG. 3 illustrates how a User Agent 104 interacts with a User Editing Tool 300 to edit Start Data 310 which may include data from a response (e.g., 110a) to create Final Data 316, which represents the completion of the User Agent's current editing of the Start Data 310. During such editing, changes are monitored by reviewing what changes the User Agent 104 makes in the User Editing Tool 300 and sending such Change Information 312 to a Change Evaluator 302 that digests such Change Information 312 into a Change Descriptor 314 that are used to learn about user preferences in the USLM 100. In some cases, the Change Evaluator 302 may be unnecessary if the USLM is equipped to handle the raw Change Information 312.

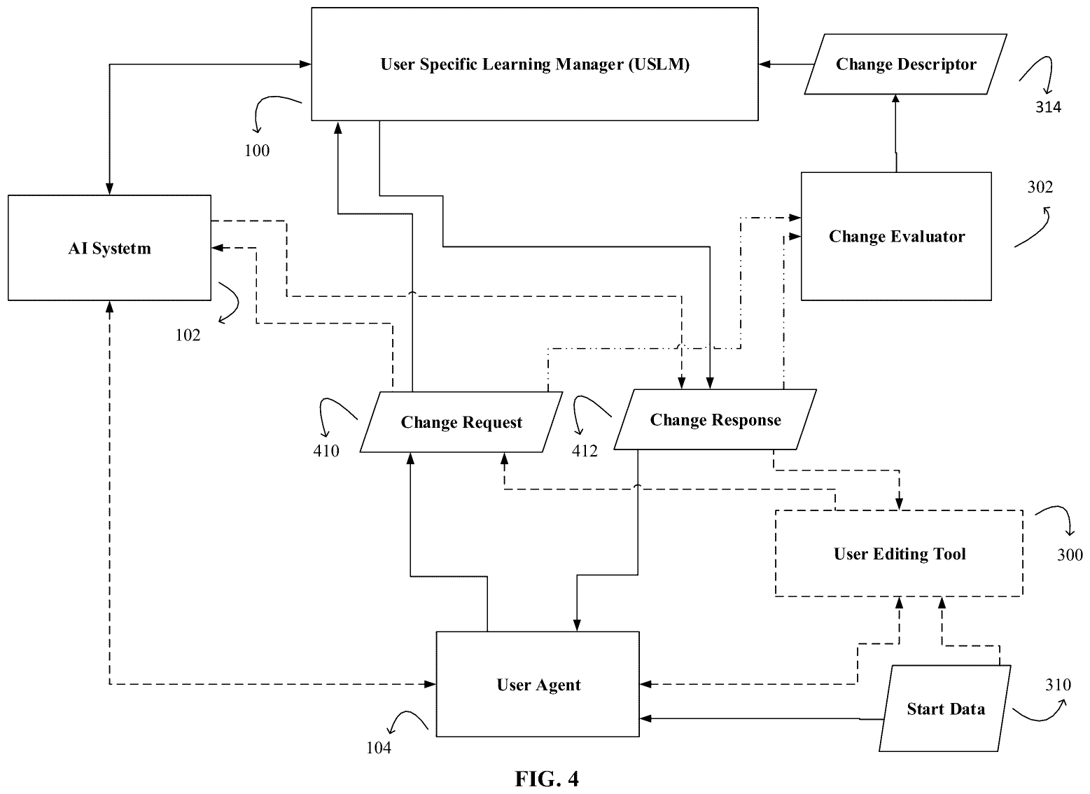

FIG. 4 illustrates how the USLM 100 can learn from changes made by a User Agent 104 to Start Data 310, which might include data from a response (e.g., 110a). After receiving the Start Data 310, the User Agent 104 provides a Change Request 410 to the USLM 100 (or in some cases directly to the AI System 102). The USLM 100 may query the AI System 102 using an original or modified version of the Change Request 410 and receive a response. The USLM 100 may then provide an original or modified version of the response as a Change Response 412 to the User Agent 104. The USLM 100 may learn directly from this information exchange or may employ a Change Evaluator 302 to assist it in digesting such changes into a Change Descriptor 314. In some cases, this process may be integrated into the User Editing Tool 301.

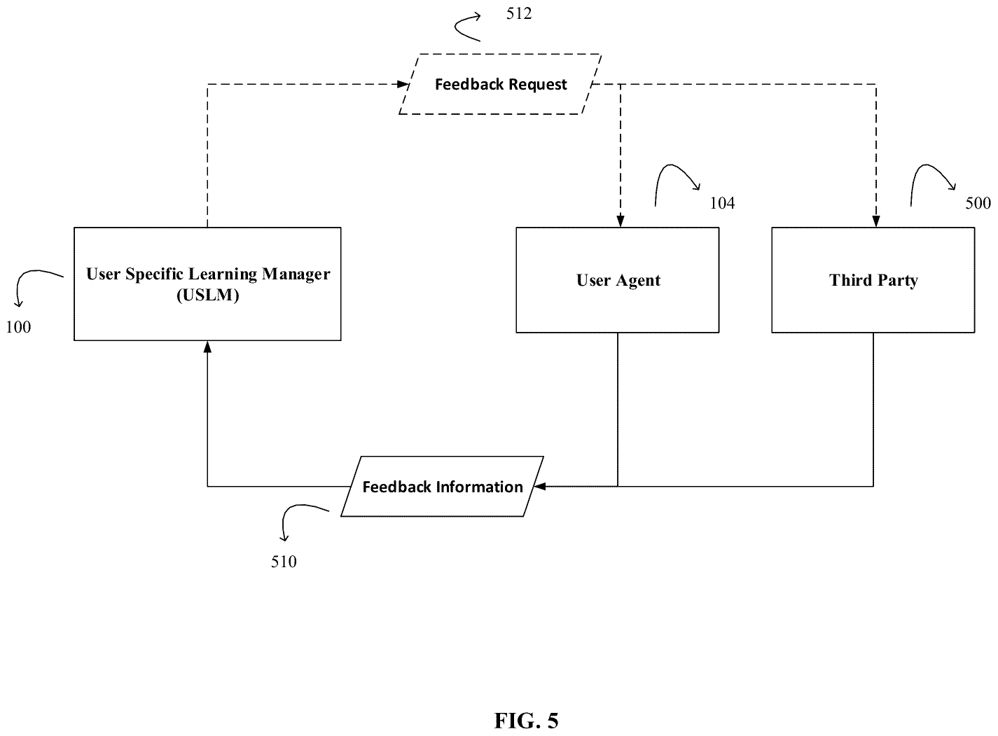

FIG. 5 illustrates how the USLM 100 can learn from feedback provided by a User Agent 104 or a Third Party 500. The USLM 100 might optionally request feedback through a Feedback Request 512 sent the User Agent 104 or a Third Party 500. A User Agent 104 or a Third Party can provide feedback through Feedback Information 510. Such Feedback information might include feedback on the sender's opinion about the quality of a Response 112a that the USLM might use to learn about a user's preferences. Third party feedback might be useful when the Third Party 500 has information that is important to the user's preferences, such as the opinion of a supervisor or customer.

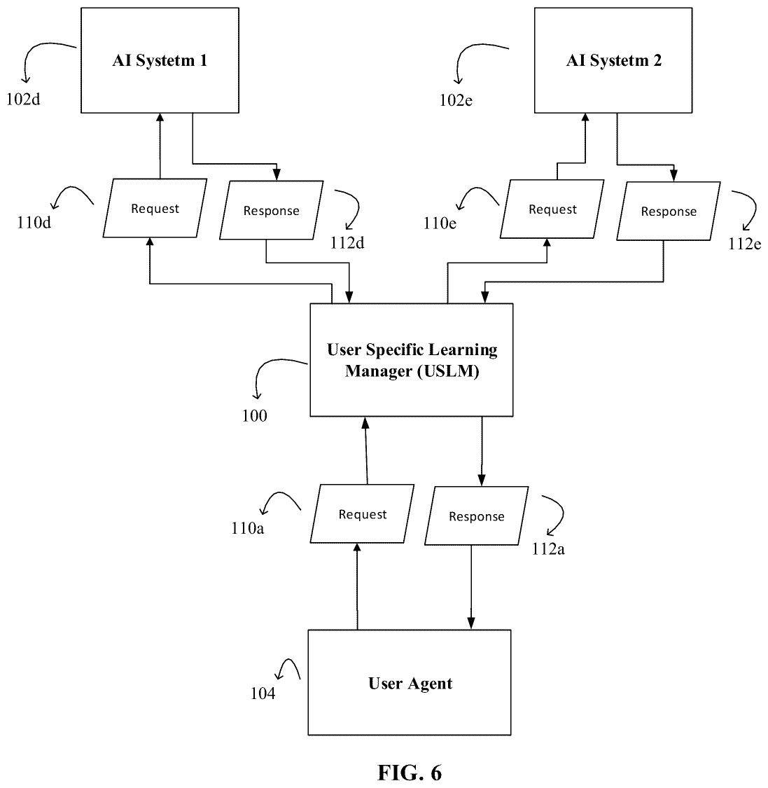

FIG. 6 illustrates how the USLM 100 might assist the User Agent 104 in selecting between AI Systems 102d and 102e. The User Agent 104 sends a Request 110a to the USLM 100, which forwards original or modified versions of the Request (e.g., 110d and 110e) to a plurality of AI Systems (e.g., 102d and 102e). Or in some cases, the USLM 100 may determine in advance that only a subset of the plurality of AI Systems will receive such Requests (e.g., 110d will be sent to 102d). Or in some cases, the USLM 100 might break the request into component sub-requests that it sends as different Requests (e.g., 110d and 110e) to a plurality of AI Systems (e.g., 102d and 102e). In any case, the USLM will receive Responses (e.g., 112d and 112e) and determine which response or combination of responses will be sent as a Response 112a to the User Agent 104. In some cases, the AI Systems 102d and 102e are actually different models, algorithms, or other elements within a single AI System when selecting between such different elements might produce a different response.

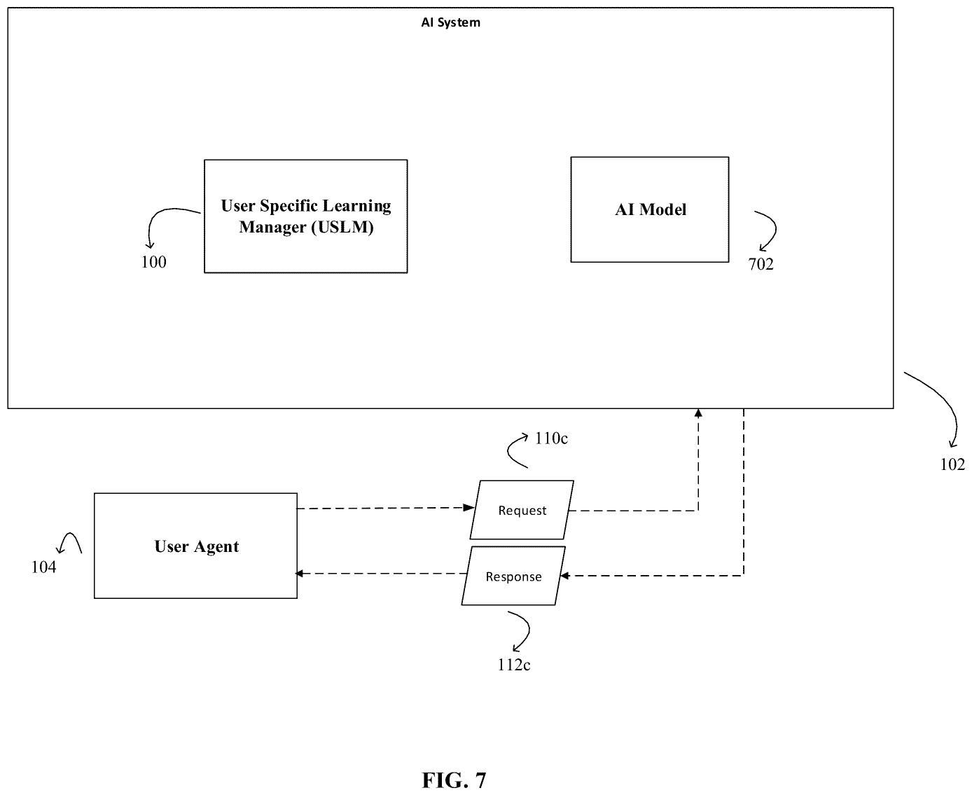

FIG. 7 illustrates how in some cases the AI System 102, or another system, might contain multiple elements of the invention in a single system. In this figure the User Agent 104 is interacting directly with the AI System 102 that contains a learning system that might modify instructions to the system's AI Model 700 to provide output information tailored for user preferences.

Example Embodiment 1: A Text-focused System Implemented through Reinforcement Learning.

In one embodiment of the system, the learning mechanism of the User Specific Learning Manager (“USLM”) will be implemented using a reinforcement learning (“RL”). This example embodiment will be targeted at a system designed to improve the quality of text generated AI results. However, the RL learning mechanism described in this example could be used to learn about and improve any media type using this invention. This example embodiment is also focused on a single type of media (text), but embodiments may process any number of media concurrently.

In this implementation, as in many other implementations, an implementor may determine how the components of the learning mechanism used to implement the USCS (here RL) will be mapped to elements of the invention such as requests, responses, change descriptors, and other elements. In this example embodiment, the RL used for the learning mechanism often requires at least the following components: an environment, a state, and a reward function. As described below, each of these RL components will be operatively connected to elements of the invention to provide the desired learning capabilities.

In this embodiment, the RL environment is represented by a series of variables of any type (e.g., vector). These variables might include the type of media being used, the current User Agent, the type and sub-type of document being created, paragraph type, sentence type, connected AI systems, the state of the interaction between the AI system and USLM, tone variables, style, formatting variables, and other variables. In some systems, new variables might be dynamically added as an as-needed basis. These variables would be different if the media were different (e.g., video type instead of document type, segment instead of paragraph, frame instead of sentence).

In this embodiment where RL is the learning mechanism, these variables also need a state, which may contain a current value for some or all of the variables that define the environment. Here the USLM may populate these variables using the current state of interaction between the USLM and the AI system (e.g., for things like connected AI systems, or connection statues), preset values, and information from the current request (e.g., 110a) from the user agent period (“Current Request”). One method for populating these variables is to query the AI system about potential values in the Current Request. For example, if the request states “create a marketing letter to Customer A about Product B,” one method for populating variables for the current state is to query an AI engine (“AI Evaluator”) about each variable. The AI evaluator can be the AI System 102 or another AI capable of evaluating the requests for the presence of attributes. One way to accomplish this is to send requests to the AI Evaluator like “What type of document is being requested in this sentence: ‘create a marketing letter to Customer A about Product B.’” Another way to accomplish the same task is to give the AI Evaluator choices like “Categorize this sentence as requesting either a letter, a memo, or an essay: ‘create a marketing letter to Customer A about Product B.’” The results from the AI Evaluator can then be used to assign values to variables in the state. For example, if the AI System returns a response “this is a marketing letter” then the variable for document type could be assigned to a value associated with the document type of letters, or more specifically to a value or combination of values associated with the document type of marketing letters. Similarly, the other variables can be populated with queries to the AI Evaluator about the Current Request's style, tone, target audience, specific addressee, and many other potential elements that will establish the RL state of the current environment. The process used for the assignment of state values might be different when the media type is different. As an example, an AI evaluator might be asked about a text prompt containing words describing a video (e.g., “what type of video is being described in this statement ‘create a marketing video about product A’) or in some cases the AI evaluator might evaluate the non-text media (e.g., “does this video contain information about product A? [attached video]” or the equivalent in another format). Such evaluations are possible with various media using examples from the generative AI systems listed in the background section of this document.

In this embodiment where RL is the learning mechanism, actions may be defined. Actions can be conceptualized as optional steps that may be taken by the RL in furtherance of an objective. Here the actions might be the possible modifications to Current Request that might improve its usefulness to the user. Because this is a text-based example, the Current Request is likely a text prompt and the modifications might include changes to the prompt (e.g., adding phrases to the prompt, like “Include discussions of product features” or “use bullet points” or “limit responses to 1000 words”). Non-text implementations might use media specific modifications. The modifications to the Current Request will be sent to the AI System 102 to receive a response 112a (“Current Response”). These actions taken to modify the Current Request will be used by the RL system in combination with the state, environment, and reward information (explained below) to learn which actions result in the highest reward for any state. This learned information will be used to determine how requests (associated with state) should be modified (by actions) to produce the responses preferred by the user (those with the highest rewards), as explained more below.

RL Actions can also determine which AI Systems will receive the Current Request and how results are selected or merged (when multiple results are received). For example, the marketing letter above could be sent to multiple AI Systems (e.g., GPT and LLaMA) and the results could be evaluated (e.g., by the user or the USLM) and the most appropriate result (or combination of results) selected. Or the Current Request might be split into sub-requests sent to several AI Systems (e.g., as GPT for the body but have LLaMA build the letter header). Or the AI System might determine in advance, based on learned user preferences, that a certain AI System, (e.g., GPT) is most suited for the current task and send the request only to that system.

Modifications to Current Requests need not be solely based on actions, for example present user preferences such as “always use the oxford comma” might be included regardless of whether they are associated with an action in RL.

In this embodiment where RL is the learning mechanism, rewards will help the RL system quantify the value of the Current Response to the User Agent 104. Here the reward might be determined by any of the methods shown in FIG. 2 (and detailed in other figures), or other methods, or a combination thereof. In this embodiment, any combination of these methods may contribute a reward value (“Reward Contribution”) to a sum that will be used to determine a final reward value for the RL system.

In one example of Reward Contribution, the value of such a reward contribution is quantified by determining how much a User Agent 104 modified the Current Response in a User Editing Tool 300. For example, if the User Agent made substantial modifications to the Current Response in the User Editing Tool, the reward would be lower (potentially even negative) than if the User Agent made few changes or unsubstantial changes before concluding that the product was in a Final State 316. The AI Evaluator (used here as the Change Evaluator 302) can be used to determine the substantialness (or other quantifiable aspects) of changes, just as it was used to determine the presence of elements above. A simple example of such a use of the AI Evaluator might be to send it a request to compare two sentences (e.g., “On a scale of 1 to 10, how different are these sentences: ‘the dog ran’ and ‘the dog ran quickly’”). In another example, the Reward Contribution might be evaluated based upon a series of weighted dimensions evaluated individually and weighted before contributing their Reward Contribution (e.g., the result of the query “On a scale of 1 to 100, how do the following two sentences compare in aggressiveness of their tone: ‘please stop that’ and ‘please stop that right now’” is weighted based on a preset or AI-determined value). See the detailed descriptions related to FIG. 3 above.

In one example of Reward Contribution, a reward is quantified by determining how much a User Agent modifies the Current Response with additional Change Requests 410. Just like in the examples above where the User Agent's changes to the text were evaluated using the AI Evaluator (used here as a Change Evaluator 302), the AI Evaluator can also evaluate either the Change Request 410 itself or the difference between the Current Response and its Change Response 412. Through this process, a value for a reward contribution can be determined by monitoring the user's requested changes for a particular response.

In some examples the RL may create a new state with which to associate a change made by the user. Where the User Agent 104 changes the text, either through the User Editing Tool 300, a Change Request 410, or another method, the RL might create a new state to track such changes made by the User Agent 104 and associate a reward related to the change. Here the reward might have a relatively high value compared to the unchanged Current Response because the User Agent may be presumed to prefer their changes over the original. In this situation, the actions may be populated from the actions taken by the User Agent to make the changes, not by the original actions that created the Current Response. Such actions can be populated by querying the AI Evaluator for the presence of available actions, or the RL might also add new actions based upon the User Agent's Changes. For example, if the user made a Change Request 410 that stated “make this sentence more detailed” then the RL can adjust the state variable associated with level of detail. If not such variable exists, it can created or the system can modify an existing variable to include such a dimension. Such new states might also be created when a reward is being calculated for more than one Current Response, like when more than one AI System is sent a Current Request, as described above.

In one example of Reward Contribution, a reward is quantified by collecting feedback from the User Agent 104 associated with the Current Response. This might include something as simple as the user giving the Current Response a “thumbs up” or “thumbs down” or might include a more complex feedback mechanism such as the incorporation multidimensional evaluation by the User Agent or survey data from the user's customers related to the Current Response. In our marketing letter scenario, reward contribution could include feedback from User Agent requesting the letter, or it might include data about feedback from the person or organization that received the letter (e.g., by using an AI evaluator to rate the sentiment in a customer's reply to the marketing letter in our example).

In one example of Reward Contribution, a reward is quantified by comparing the Current Response to existing User Agent Data. One way this could be accomplished would be by asking the AI evaluator to compare different dimensions of the Current Response to similar existing works of the User Agent. In the marketing letter scenario, the AI evaluator might scan the User Agent's existing work for marketing letters and compare them for dimensions like format, style, tone, or any other comparable dimensions). In another scenario the AI evaluator might compare the Current Response to social media posts that the user has “liked.” In a non-text example, the AI evaluator might compare a generated commercial video to commercials videos that the user has identified as having attributes that they are targeting for Current Response.

Another example of how Existing User Data 200 might be used includes merging information to a prompt in a Current Request. In the marketing letter scenario where the letter is addressed to Customer A, the contact information for Customer A can be merged into the Current Request using existing user data.

The Reward Contributions can also be used with a “retry” mechanism. If a Current Response receives a Reward Contribution below a certain threshold (predefined or determined by AI) prior to being presented to the user, the USLM might retry the request with different actions until the minimum reward value is met (or another condition, like a timeout, occurs). This could reduce the user's need to provide editing or other feedback on responses that are unlikely to be valuable to the user.

Because in this example implementation, the RL tracks the AI System that is in use (e.g., 600a), the RL system can learn about which AI Systems, or combinations thereof, provide the most valuable results for the User Agent. This learning can subsequently be used to enable the USLM to make determinations about selecting between or combining requests or responses to or from different AI Systems, as discussed above.

As the RL system learns about the preferences of the User Agents, each User Agent will begin to experience increasingly valuable results. A User Agent can now make a simple request like “create a marketing letter for Customer A” and receive a very detailed response that is customized for their individual needs and preferences.

### Discussion of Other Embodiments

The example above was specific to both (a) a system for processing text and (b) use of a reinforcement learning (RL) system to learn about changes. While this example embodiment provides a simple example that helps illustrate the benefits of the invention, it is not necessarily the best embodiment of the invention. The best embodiment of the invention could be determined by matching the media being processed (or combinations thereof) to the learning system (or combinations thereof) being used as the USLM's learning mechanism. For example, some learning systems, such as large language models, might be best for processing large amounts of text. Other learning systems, such as 2D/3D convolutional neural networks or generative adversarial networks, might be best for processing video or images. Often times using a combination of learning systems, such as RL with a neural network, can produce best results when learning about user preferences. In this invention, the specifics of the learning system are abstracted to be compatible with any learning system. Rather than disclosing a specific system for learning, this invention discloses a system by which generative AI might produce better results by learning about the preferences of specific users and tailoring results to such users.

### Definitions

The User Specific Learning Manager 100 is any process that learns from User Agent 105 activities and subsequently modifies or routes requests directed to an AI System in an attempt to improve the resulting response generated by the AI System or by selecting or anticipating the AI System with the likely best response. This process could be implemented by algorithms, machine learning, or artificial intelligence. It could be implemented through hardware or software or a combination of both. The User Specific Learning Manager can be part of any other process or function and need not stand alone. In this document all references to User Specific Learning Manager, learning manager, learner, or similar references shall be construed as references to this definition, or a broader definition as established by their use in context. References to the invention “learning” should be similarly construed.

AI Systems 102 include any artificial intelligence systems that receive input and subsequently generate output based to correspond to such input. Examples can include, but are not limited to, systems that generate text, video, audio, images, 3D models, computer code, binary results, structured data, and many other forms of media or output. Such systems also include processes for modifying or editing, not necessarily generating, works of any of the previously mentioned types of media or outputs. The AI Systems can be a stand-alone system or AI components inside another system. The use of the term “generative” AI systems should not be construed as a restriction to systems that are categorized as “generative” within the art. For the purposes of this document, any system that takes input and generates a subsequent output can be considered a generative AI system, even if it might be categorized otherwise under current or future usage of the term. In this document all references to AI systems, generative AI systems, generative AI, or similar references shall be construed as references to this definition, or a broader definition as established by their use in context.

User Agents 104 can be person or process that makes requests to and receives responses from a generative AI system. The invention supports a polarity of User Agents and can track each user separately to provide them each with the benefits of the invention. This includes both human users or software processes. In this document, all references to users shall be construed as references to this definition, or a broader definition as established by their use in context.

Requests e.g., 110a, 100b, 110c represent an input to an AI System that provide information about what an output that might be generated. These inputs can be text, binary, structured data, vectors, unstructured data, numbers, video, audio, images, other media, boolean values or other forms of input. Many of the examples in this document use the example of text prompts, such as “write a letter from me to customer A.” However, these examples are used primarily because they make the specification easier to understand. In such examples, an AI System might instead require a vector input containing instructions that are not human-readable. In this document, all references to Requests, prompts, inputs, and similar terms shall be construed as references to this definition, or a broader definition as established by their use in context.

Responses e.g., 112a, 112b, 112c represent the output of an AI based upon inputs provided. These responses can be text, numbers, vectors, images, video, audio, other media, structured data, unstructured data, or other forms of output from an AI System. Many of the examples in this document focus on text outputs. These examples are used to create easily readable examples for the purposes of explaining this invention. The use of text examples for responses should not be construed in any way to limit the invention to text-based AI responses. Responses, outputs, generated text, and similar terms shall be construed as references to this definition, or a broader definition as established by their use in context.

Existing User Agent Data e.g., 200 might include any data that can be used to learn user preferences. For example, preset user preferences, media created by the user, media created by sources other than the user but that have been identified as useful for determining user preferences, user history information (e.g., history of messages, chats, searches, etc.), and other information that exists prior to a determination deemed useful for such a determination. In some cases, such data might also include data that will be merged into responses or requests, such as customer lists, logos, stock photos, and other reusable content. Existing user agent data, user data, and similar terms shall be construed as references to this definition, or a broader definition as established by their use in context.

User Preferences or preferences means results that might be preferred by the user over other potential results. This definition should not be limited by how the term “preferences” is used in this or other arts. User preferences, preferences, and similar terms shall be construed as references to this definition, or a broader definition as established by their use in context.

What is claimed is:

1. A method comprising:
receiving a request from a user to be processed by a generative artificial intelligence (AI) system;
modifying the request to create a modified request, wherein modifying the request is based at least in part on pre-determined user preferences;
forwarding the modified request to the generative AI system;
receiving a response from the generative AI system based on the modified request; and
displaying the response to the user.
